(19) United States
(12) Patent Application Publication
(10) Pub. No.: US 2026/0097936 A1
(43) Pub. Date: Apr. 9, 2026

(54) STRUT STRUCTURE FOR A CRANE DETACHABLE INTO TWO SUB-ASSEMBLIES

(71) Applicant: MANITOWOC CRANE GROUP FRANCE, DARDILLY (FR)

(72) Inventor: Mayeul JUSNEL, SAINT CHAMOND (FR)

(21) Appl. No.: 19/348,462

(22) Filed: Oct. 2, 2025

(30) Foreign Application Priority Data
Oct. 4, 2024 (FR) FR2410718

(51) Int. Cl. B66C 23/82

(52) U.S. Cl. CPC B66C 23/823

(57) ABSTRACT

A strut structure for a crane, comprising a strut arm including a foot and a top, wherein the strut arm is divided into an upper strut half-arm to which at least one tie rod is fastened, and a lower strut half-arm to which at least one reinforcing bar is fastened, which are assembled by a detachable intermediate mechanical connection, such that the strut structure is detachable into two sub-assemblies, after disassembly of the detachable intermediate mechanical connection, which are an upper sub-assembly comprising the upper strut half-arm and the at least one tie rod, and a lower sub-assembly comprising the lower strut half-arm and the at least one reinforcing bar.

### FIELD

The present disclosure relates to a strut structure for a crane.

It relates more particularly to a strut structure including a strut arm, and at least one tie rod and at least one reinforcing bar fastened on one side to the strut arm and intended to be fastened on the other side to a counter-jib of the crane.

The present disclosure finds application in the field of cranes, and in particular element-assembled cranes.

### BACKGROUND

As is known, an element-assembled crane (or top-slewing crane) is composed of independent structural elements, also called frame elements, which are assembled to form a structure or frame, and in particular to form a mast also called a pylon (made of several mast elements), a base on which the mast is mounted, as well as a rotating part which comprises a jib holder at the top of the mast, a jib (made of several jib elements) hingedly mounted on the front of the jib holder, a counter-jib mounted on the rear of the jib holder, and a strut structure mounted on the counter-jib.

The state of the art can be illustrated by the teachings of document CN 110 745 711 B which discloses a strut structure for a crane, comprising a strut arm including a foot and a top, a tie rod including an upper tie rod end fastened to the top of the strut arm, and a reinforcing bar including an upper bar end fastened to the strut arm, between the foot and the top.

In the particular case of very high cranes, for example over 70 meters high, it is necessary to use jib cranes fastened directly to the building that has just been constructed, in order to disassemble the various elements, and in particular the elements of the rotating part. Indeed, mobile cranes, generally used for such disassembly, do not generally allow access to such heights.

However, the maximum payload of these jib cranes generally does not exceed 10 tons. Also, if the mass of an element of the crane exceeds 10 tons, it becomes difficult to disassemble this element. Also, it is common, for an application to a high-rise crane, to use only elements having a mass of less than 10 tons, which can limit the capacity of the crane, in particular its load curve, its maximum lifting capacity and its lifting capacity at the end of the jib.

### SUMMARY

The object of the present disclosure is to respond in whole or in part to the problem mentioned above, namely to be able to propose a high-rise crane which is not limited in its capacities because of the weight of its elements, and in particular the weight of its strut structure.

To this end, the present disclosure proposes a strut structure for a crane, comprising:
a strut arm including a foot and a top;
at least one tie rod including an upper tie rod end fastened to the top of the strut arm; and
at least one reinforcing bar including an upper bar end fastened to the strut arm, between the foot and the top.

This geometry of the strut structure is in fact suitable for high-rise cranes, notably with the use of at least one reinforcing bar (also called a counter-buckling bar) whose function is to prevent buckling of the strut arm, particularly under heavy load at the end of the jib. In fact, to avoid excessive deformation under load, the strut arm must be supported substantially in its middle by one or several reinforcing bars which therefore cut the triangle formed by the strut arm and the tie rod(s) into two other triangles formed respectively by the strut arm and the reinforcing bar(s) (lower triangle) and by the tie rod(s) and the reinforcing bar(s) (upper triangle).

This strut structure is remarkable in that the strut arm is divided into an upper strut half-arm and a lower strut half-arm assembled end to end by a detachable intermediate mechanical connection, the foot being part of the lower strut half-arm and the top being part of the upper strut half-arm; and in that the upper bar end of the at least one reinforcing bar is fastened to the lower strut half-arm; so that the strut structure is detachable into two sub-assemblies, after disassembly of the detachable intermediate mechanical connection, which are an upper sub-assembly comprising the upper strut half-arm and the at least one tie rod, and a lower sub-assembly comprising the lower strut half-arm and the at least one reinforcing bar.

Thus, the design of the strut structure is based on a division into two sub-assemblies of generally triangular shape, such that the upper sub-assembly can be disassembled from the lower sub-assembly and from the counter-jib in order to be carried separately, then the lower sub-assembly can be disassembled from the counter-jib in order to be carried separately in turn, before disassembly of the counter-jib which constitutes another element.

In fact, by fastening the reinforcing bar(s) to the lower strut half-arm, therefore below the detachable intermediate mechanical connection, the lower sub-assembly (forming a triangular structure formed by the lower strut half-arm and the reinforcing bar(s)) can remain in place on the counter-jib, while the upper sub-assembly can be disassembled.

In a particular embodiment, the strut structure comprises at least one connecting element for a mechanical connection between the at least one reinforcing bar and the at least one tie rod, wherein the at least one reinforcing bar includes a lower bar end fastened to the at least one connecting element, and the at least one tie rod includes a lower tie rod end which is assembled on the at least one connecting element by at least one detachable lower mechanical connection, so that the lower sub-assembly comprises the at least one connecting element, fastened to the at least one reinforcing bar, after disassembly of the at least one detachable lower mechanical connection.

Thus, the or each tie rod is disassembled from the connecting element (and is therefore separated from the reinforcing bar(s)), for the disassembly and winching of the upper sub-assembly, without the reinforcing bar(s) being disassembled from the counter-jib. It is only in a second step, after having detached the upper sub-assembly, that the reinforcing bar(s) can be detached from the counter-jib to be able to detach and winch the lower sub-assembly in turn.

According to one feature, the at least one detachable lower mechanical connection is a pin connection which comprises at least one lower connecting pin providing a junction between the lower tie rod end of the at least one tie rod and the connecting element.

It should be noted that the pin connection consists of a detachable assembly comprising a connecting pin (also called a spindle or shaft) passing through two elements, such as for example a clevis and a tenon in order to have a clevis/tenon connection.

According to another feature, the lower bar end of the at least one reinforcing bar is securely fastened to the at least one connecting element, for example by welding.

In a particular embodiment, the at least one reinforcing bar includes a length adjustment arrangement for adjusting the length of the at least one reinforcing bar.

Such a length adjustment arrangement is advantageous because it makes it possible to avoid hyperstaticity in the assembly of the strut structure; the adjustment of the length of the reinforcing bar(s) giving an advantageous degree of freedom to facilitate the mounting operations.

According to one possibility, the length adjustment arrangement comprises a screw tensioner equipped with a nut with reverse threads, such as for example a lantern nut.

According to another possibility, the detachable intermediate mechanical connection is a pin connection which comprises at least one intermediate connecting pin providing a junction between the upper strut half-arm and the lower strut half-arm.

According to another possibility, the upper strut half-arm comprises a lower end on the opposite side of the top, the lower strut half-arm comprises an upper end on the opposite side of the foot, and the at least one intermediate connecting pin provides a junction between this lower end and this upper end.

Advantageously, the upper bar end of the at least one reinforcing bar is fastened to the upper end of the lower strut half-arm.

According to one possibility, the strut arm includes two sections of the strut arm, which are a right section of the strut arm and a left section of the strut arm, where:
the right section of the strut arm is divided into an upper right half-section of the strut arm and a lower right half-section of the strut arm assembled end to end by the detachable intermediate mechanical connection;
the left section of the strut arm is divided into an upper left half-section of the strut arm and a lower left half-section of the strut arm assembled end to end by the detachable intermediate mechanical connection;
the upper strut half-arm comprises the upper right half-section of the strut arm and the upper left half-section of the strut arm secured to each other;
the lower strut half-arm comprises the lower right half-section of the strut arm and the lower left half-section of the strut arm secured to each other.

According to one variant, the at least one tie rod comprises two tie rods which are a right tie rod and a left tie rod fastened respectively to the upper right half-section of the strut arm and the upper left half-section of the strut arm.

According to one feature, the at least one reinforcing bar includes two reinforcing bars which are a right reinforcing bar and a left reinforcing bar fastened respectively to the lower right half-section of the strut arm and the lower left half-section of the strut arm.

In an advantageous embodiment, the right reinforcing bar and the left reinforcing bar each include the length adjustment arrangement.

Thus, the length of each of the two reinforcing bars can be adjusted independently.

According to another feature, the at least one connecting element comprises two connecting elements which are a right connecting element and a left connecting element, where the right reinforcing bar is fastened to the right connecting element and the left reinforcing bar is fastened to the left connecting element.

According to one possibility, the at least one detachable lower mechanical connection comprises a right detachable lower mechanical connection and a left detachable lower mechanical connection which respectively connect the right tie rod to the right connecting element and the left tie rod to the left connecting element.

In a particular embodiment, the upper sub-assembly has a first mass that is less than 10 tons, the lower sub-assembly has a second mass that is less than 10 tons and the strut structure has a total mass that corresponds to the sum of the first mass and the second mass and that is greater than 10 tons.

The invention also relates to a crane comprising a rotating part at the top of a mast, said rotating part comprising a jib holder, a jib hinged on the jib holder, a counter-jib mounted on the jib holder and a strut structure as described above, wherein the foot of the strut arm is assembled on the counter-jib by a first detachable mechanical connection, the at least one tie rod and the at least one reinforcing bar are assembled on the counter-jib by a second detachable mechanical connection.

According to one feature, the at least one connecting element is assembled on the counter-jib by the second detachable mechanical connection.

### BRIEF DESCRIPTION OF THE DRAWINGS

Other features and advantages of the present disclosure will become apparent upon reading the detailed description below, of a non-limiting example of implementation, made with reference to the appended figures in which:

FIG. 1 is a schematic side and partial view of a rotating part of a crane, in which the jib holder, the jib, the counter-jib and the strut structure are visible;

FIG. 2 is a schematic side view of the strut structure of FIG. 1 during a slinging manipulation, with a zoom on a toggle leg in the toggled position;

FIG. 3 is a schematic side view of the strut structure of FIG. 1 in position on the counter-jib, where the at least one toggle leg is in a rest position, and comprising a first zoom on a connecting element between a tie rod, a reinforcing bar and the counter-jib, and a second zoom on a detachable intermediate connection between an upper half-strut and a lower half-strut;

FIG. 4 is a schematic perspective and partial view of the strut structure of FIG. 2 in position on the counter-jib;

FIG. 5 is a schematic view of the strut structure of FIGS. 1 to 3 once disassembled into two sub-assemblies;

FIG. 6 is a schematic perspective view zoomed on the connecting element between the tie rod, the reinforcing bar and the counter-jib, and on the arrangement for adjusting the length of the reinforcing bar;

FIG. 7 is a schematic side and partial view of the strut structure of FIGS. 1 to 3, comprising a zoom on the connecting element between the tie rod, the reinforcing bar and the counter-jib, and on the arrangement for adjusting the length of the reinforcing bar.

### DETAILED DESCRIPTION

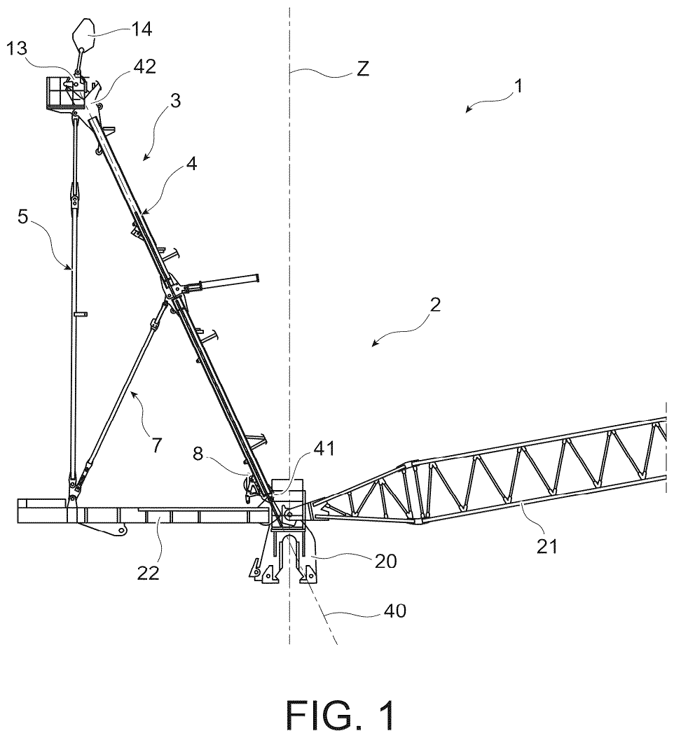

Referring to FIG. 1, a crane 1, here a luffing jib crane and element-assembled crane, comprises a base frame (not illustrated), static or movable on the ground, above which rises a mast (not illustrated) which extends along a vertical axis Z and which has a top on which is mounted, by means of a slewing device (not illustrated), a rotating part 2 orientable around the vertical axis Z.

This rotating part 2 comprises a jib holder 20 at the top of the mast, a jib 21 (made of several jib elements) hingedly mounted on the front of the jib holder 20, a counter-jib 22 mounted on the rear of the jib holder 20, and a strut structure 3 mounted on the counter-jib 22.

The jib 21 is movably mounted in rotation about a horizontal axis on the jib holder 20 so that the jib 21 can be raised and lowered.

The counter-jib 22 is fixedly mounted on the jib holder 20 in order to be rotationally secured thereto. The counter-jib 22 comprises a platform for carrying equipment which comprises, in particular, a raising winch 10 connected to the jib 21 for raising/lowering the jib 21 and a lifting winch 11 connected to a lifting hook (not illustrated) for lifting loads. The counter-jib 22 also carries counterweights 12.

More specifically, the raising winch 10 has a drum, around which is wound a raising cable which passes over a pulley 13 arranged at the top of the strut structure 3, and which also passes over the pulleys of a raising block 14 (illustrated in FIG. 1), located at the top 42 of the strut structure 3. The raising block 14 is connected, by a line of tie rods (not illustrated), to the jib 21.

The lifting winch 11 has a drum around which is wound a lifting cable, which passes through the strut structure 3, passes over at least one pulley (not illustrated) arranged on the jib 21, then is directed towards the tip of the jib 21 and extends to the lifting hook, with or without a reeving system; the loads to be lifted being suspended from the lifting hook when using the crane 1.

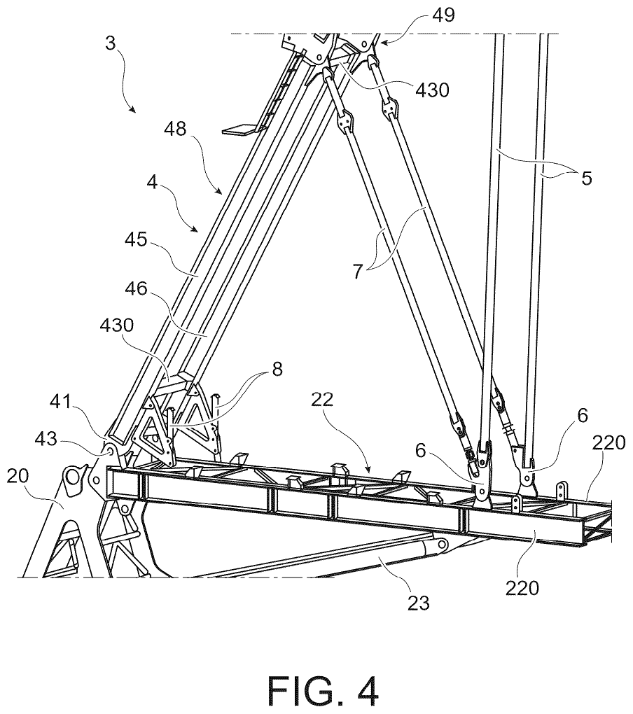

The counter-jib 22 can be mechanically coupled to the jib holder 20 by means of a reinforcing beam 23 (visible in FIG. 4) extending between the underside of the counter-jib 22 and the jib holder 20.

The strut structure 3 comprises a strut arm 4 extending longitudinally along a strut axis 40 and including a foot 41 and a top 42 (this top 42 forming the top of the strut structure 3). In position, this strut arm 4 extends obliquely upwards and backwards. The strut axis 40 is thus inclined backwards relative to the vertical axis Z at a strut angle comprised between 10 and 50 degrees.

The foot 41 of the strut arm 4 is assembled on the counter-jib 22 by a first detachable mechanical connection 43 which may be a pin connection; a pin connection consisting of a detachable assembly comprising a connecting pin (also called a spindle or shaft) passing through two elements, such as for example a clevis and a tenon in order to have a clevis/tenon connection.

The top 42 of the strut arm 4 is equipped with a hooking member 420 for hooking a sling, such as for example a hooking ring or slinging ring.

The strut structure 3 also comprises at least one tie rod 5 including an upper tie rod end 51 fastened to the top 42 of the strut arm 4 and a lower tie rod end 52 assembled on the counter-jib 22 by a second detachable mechanical connection 60 which may be a pin connection. Thus, in operation, the strut arm 4 is retained by the counter-jib 22 by means of the tie rod(s) 5.

The strut structure 3 comprises at least one reinforcing bar 7 including an upper bar end 71 fastened to the strut arm 4, between the foot 41 and the top 42, and a lower bar end 72 assembled on the counter-jib 22.

The strut structure 3 comprises at least one connecting element 6 for a mechanical connection between the at least one reinforcing bar 7 and the at least one tie rod 5. This at least one connecting element 6 is designed to be assembled on the counter-jib 22 by the second detachable mechanical connection 60 which, as a reminder, may be a pin connection.

The lower tie rod end 52 of the at least one tie rod 5 is assembled on the connecting element 6 by at least one detachable lower mechanical connection 53 which may be a pin connection comprising a lower connecting pin 530.

The lower bar end 72 of the at least one reinforcing bar 7 is fastened to the connecting element 6. The lower bar end 72 of the at least one reinforcing bar 7 may be securely fastened to the connecting element, for example by welding.

Thus, the at least one tie rod 5 and the at least one reinforcing bar 7 are assembled on the counter-jib 22 by the second detachable mechanical connection 60 of the at least one connecting element 6.

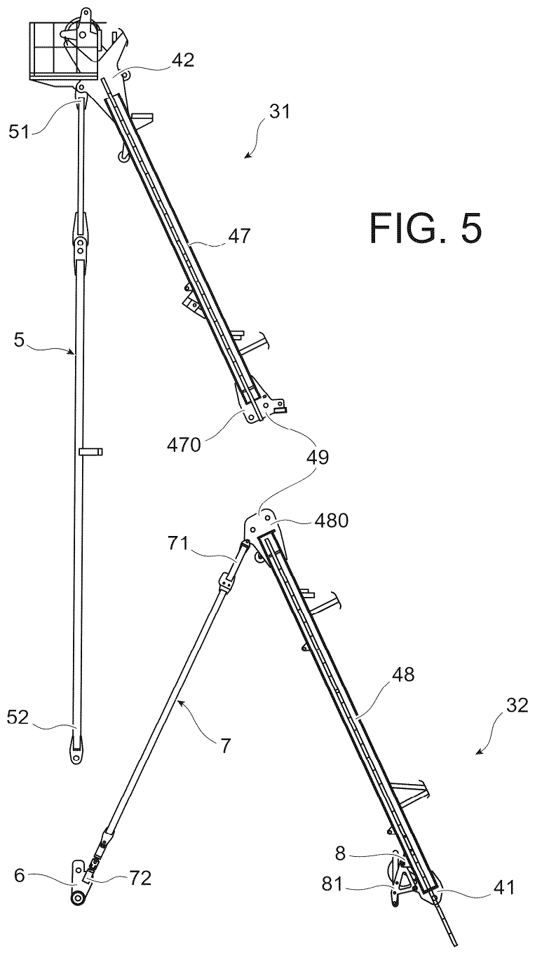

According to one possibility, the at least one reinforcing bar 7 includes a length adjustment arrangement 73 for adjusting the length of the at least one reinforcing bar 7, as visible in FIG. 4 and FIG. 5, which is for example positioned at the lower bar end 72.

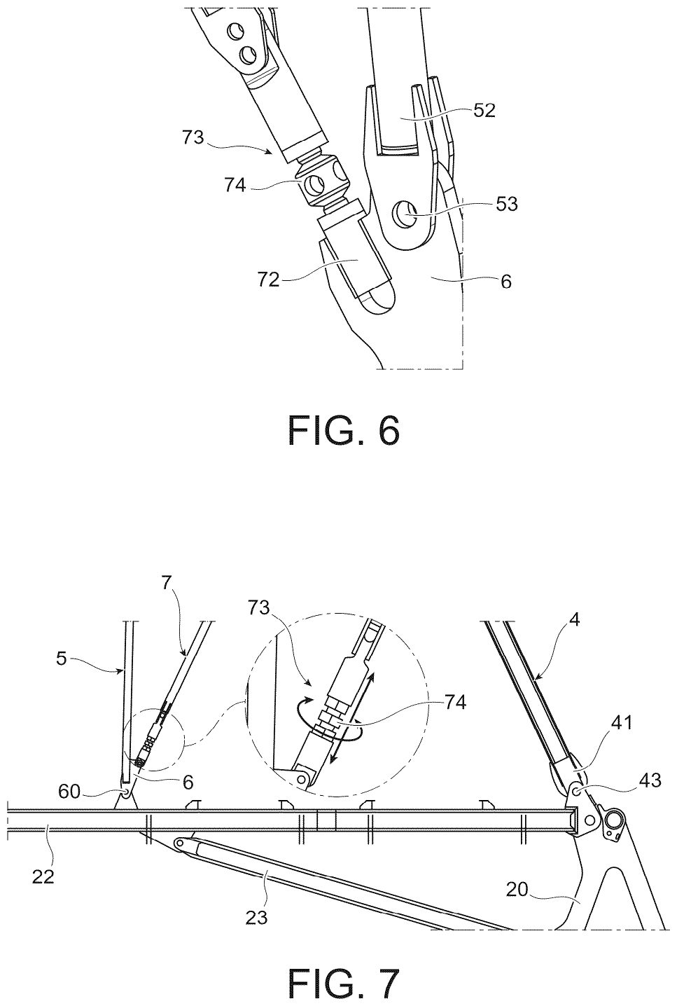

In the illustrated example visible in FIGS. 6 and 7, this length adjustment arrangement 73 comprises a screw tensioner equipped with a nut with reverse threads 74, such as for example a lantern nut.

Such a length adjustment arrangement 73 is advantageous because it makes it possible to avoid hyperstaticity in the assembly of the strut structure 3; the adjustment of the length of the reinforcing bar(s) 7 giving an advantageous degree of freedom to facilitate the assembly operations.

As visible in FIG. 4:
the strut arm 4 includes two sections 45, 46 of the strut arm, which are a right section 45 of the strut arm and a left section 46 of the strut arm which extend parallel along the strut axis 40 and which are joined by means of the foot 41, the top 42 and intermediate spacers 430;
the at least one tie rod 5 includes two tie rods 5, which are a right tie rod and a left tie rod that extend parallel to each other, wherein the right tie rod is fastened to the top 42 of the strut arm 4 on the side of the right section 45 of the strut arm, and the left tie rod is fastened to the top 42 of the strut arm 4 on the side of the left section 46 of the strut arm;
the at least one reinforcing bar 7 includes two reinforcing bars 7, which are a right reinforcing bar 7 and a left reinforcing bar 7 that extend parallel to each other, wherein the right reinforcing bar 7 is fastened to the right section 45 of the strut arm and the left reinforcing bar 7 is fastened to the left section 46 of the strut arm; and
the at least one connecting element 6 comprises two connecting elements 6 which are a right connecting element 6 and a left connecting element 6, arranged side by side on two separate beams 220 of the counter-jib 22, wherein the right connecting element 6 is assembled with the right tie rod 5 and the right reinforcing bar 7, and the left connecting element 6 is assembled with the left tie rod 5 and the left reinforcing bar 5.

Thus, the lower tie rod end 52 of the right tie rod 5 is assembled on the right connecting element 6 by a right detachable lower mechanical connection 53, and the lower tie rod end 52 of the left tie rod 5 is assembled on the left connecting element 6 by a left detachable lower mechanical connection 53. In other words, the at least one detachable lower mechanical connection 53 comprises a right detachable lower mechanical connection 53 and a left detachable lower mechanical connection 53 which respectively connect the right tie rod 5 to the right connecting element 6 and the left tie rod 5 to the left connecting element 6.

Furthermore, the lower bar end 72 of the right reinforcing bar 7 is fastened to the right connecting element 6, and the lower bar end 72 of the left reinforcing bar 7 is fastened to the left connecting element 6.

In the illustrated example, the right reinforcing bar 7 and the left reinforcing bar 7 each include the length adjustment arrangement 73.

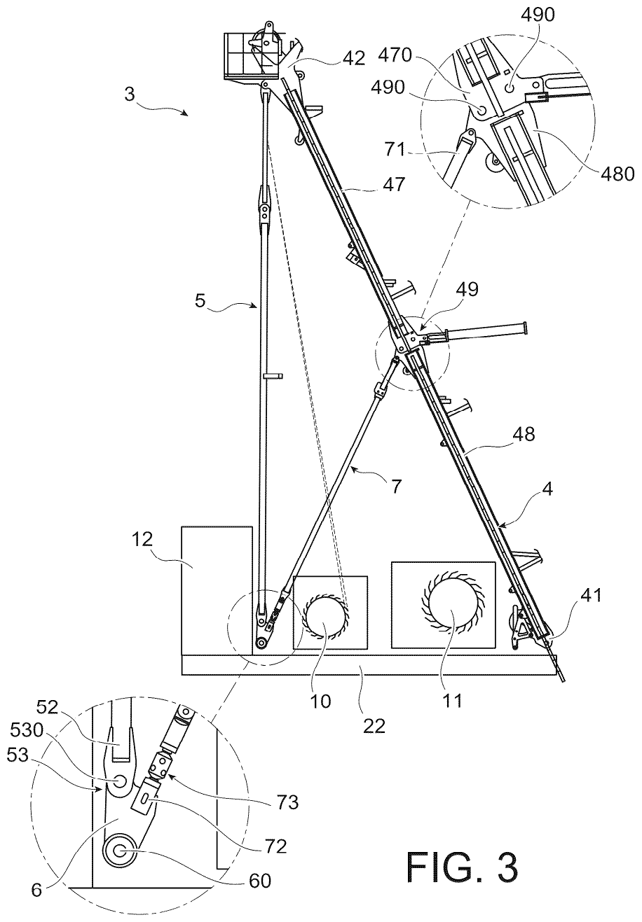

According to one feature and as visible in FIGS. 3 and 5, the strut arm 4 is divided into an upper strut half-arm 47 and a lower strut half-arm 48 assembled end to end by a detachable intermediate mechanical connection 49, the foot 41 forming part of the lower strut half-arm 48 and the top 42 forming part of the upper strut half-arm 47.

This detachable intermediate mechanical connection 49 may be a pin connection which comprises at least one intermediate connecting pin 490 providing a junction between the upper strut half-arm 47 and the lower strut half-arm 48. In the example illustrated, the detachable intermediate mechanical connection 49 comprises two intermediate connecting pins 490.

The upper strut half-arm 47 comprises a lower end 470 on the opposite side of the top 42, the lower strut half-arm 48 comprises an upper end 480 on the opposite side of the foot 41 and the at least one intermediate connecting pin 490 provides a junction between this lower end 470 and this upper end 480.

Furthermore, the upper bar end 71 of the at least one reinforcing bar 7 is fastened to the lower strut half-arm 48. According to one possibility, the upper bar end 71 of the at least one reinforcing bar 7 is fastened to the upper end 480 of the lower strut half-arm 48, as visible in FIG. 3.

As a reminder, in the example illustrated, the strut arm 4 includes two sections 45, 46 of the strut arm, which are a right section 45 of the strut arm and a left section 46 of the strut arm, such that:
the right section 45 of the strut arm is divided into an upper right half-section of the strut arm and a lower right half-section of the strut arm of the assembled end to end by the detachable intermediate mechanical connection 49;
the left section 46 of the strut arm is divided into an upper left half-section of the strut arm and a lower left half-section of the strut arm assembled end to end by the detachable intermediate mechanical connection 49;
the upper strut half-arm 47 comprises the upper right half-section of the strut arm and the upper left half-section of the strut arm secured to each other;
the lower strut half-arm 48 comprises the lower right half-section of the strut arm and the lower left half-section of the strut arm secured to each other.

Thus, the right tie rod 5 and the left tie rod 5 are fastened respectively to the upper right half-section of the strut arm and the upper left half-section of the strut arm, and the right reinforcing bar 7 and the left reinforcing bar 7 are fastened respectively to the lower right half-section of the strut arm and the lower left half-section of the strut arm.

Thus, and as visible in FIG. 5, the strut structure 3 is detachable into two sub-assemblies, after disassembly of the detachable intermediate mechanical connection 49 and of the at least one detachable lower mechanical connection 53, which are:
an upper sub-assembly 31 comprising the upper strut half-arm 47 and the at least one tie rod 5 (or the two tie rods 7 in the illustrated example); and
a lower sub-assembly 32 comprising the lower strut half-arm 48 and the at least one reinforcing bar 7 (or the two reinforcing bars 7 in the illustrated example) and the at least one connecting element 6 (or the two connecting elements 6 in the illustrated example) which remains attached to the at least one reinforcing bar 7.

Thus, the design of the strut structure 3 is based on a division into two sub-assemblies 31, 32 of generally triangular shape, such that the upper sub-assembly 31 can be disassembled from the lower sub-assembly 32 and from the counter-jib 22 in order to be carried separately, then the lower sub-assembly 32 can be disassembled from the counter-jib 22 in order to be carried separately in turn, before disassembly of the counter-jib 22 which constitutes another element.

According to one possibility, the upper sub-assembly 31 has a first mass which is less than 10 tons, the lower sub-assembly 32 has a second mass which is less than 10 tons and the strut structure 3 has a total mass which corresponds to the sum of the first mass and the second mass and which is greater than 10 tons.

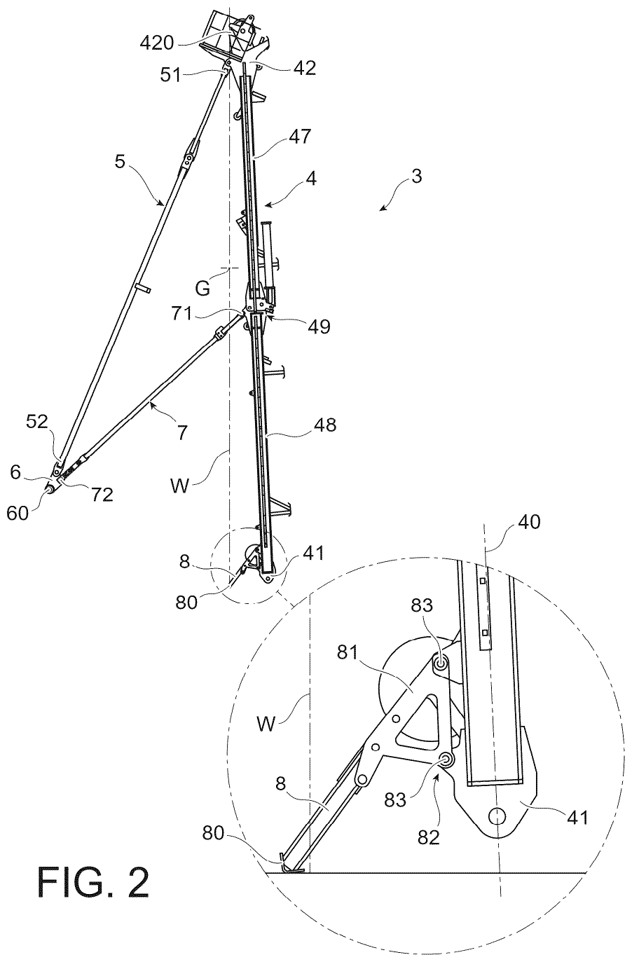

The strut structure 3 comprises at least one toggle leg 8 mounted on the foot 41 of the strut arm 4 in front of the tie rod 5 (therefore on the rear side or on the side of the counter-jib 22) and having a lower end 80 intended to form a toggle footing for the strut structure 3 because, in a toggled position (illustrated in FIG. 2), this at least one toggle leg 8 is deployed to have its lower end 80 below the foot 41 of the strut arm 4 when a theoretical balance axis W is disposed vertically (that is to say that the theoretical balance axis W extends parallel to the vertical axis Z); this theoretical balance axis W being an axis passing through the hooking member 420 and through the center of gravity G of the strut structure 3.

As visible in FIG. 2, in the toggled position of the toggle leg 8, the theoretical balance axis W is positioned between the lower end 80 of the at least one toggle leg 8 and the strut axis 40 when this theoretical balance axis W is disposed vertically; in other words, the lower end 80 of the at least one toggle leg 8 is behind (counter-jib side) the theoretical balance axis W, thus promoting the balancing of the strut structure 3 to prevent it from falling.

This at least one toggle leg 8 is movable or stowable into a rest position (illustrated in FIGS. 1, 3, 4 and 5), in which the at least one toggle leg 8 is stowed to have its lower end 80 above the foot 41 of the strut arm 4 when the theoretical balance axis W is disposed vertically.

Thus, this at least one toggle leg 8 is mounted movably on a support 81 between its toggled position and its rest position; this support 81 being assembled on the foot 41 of the strut arm 4 by a mechanical connection 82, and for example by a detachable mechanical connection such as a pin connection which comprises at least one connecting pin 83 providing a junction between the support 81 and the foot 41 of the strut arm 4.

Further provided is a locking mechanism mounted on the support 81 for locking the at least one toggle leg 8 in the toggled position and in the rest position. This locking mechanism may comprise a locking spindle which passes through the support 81 to block the toggle leg 8 in the toggled position and in the rest position.

As visible in FIG. 4, the at least one toggle leg 8 comprises two toggle legs 8 which are a right toggle leg 8 attached to the right section 45 of the strut arm and a left toggle leg 8 attached to the left section 46 of the strut arm.

In position on the crane 1, that is to say once the strut structure 3 is mounted and assembled on the counter-jib 22, the at least one toggle leg 8 is in its rest position. The at least one toggle leg 8 is even placed in its rest position during assembly on the counter-jib 22, so as not to interfere with or abut on the counter-jib 22, in particular during assembly of the foot 41 of the strut arm 4 on the counter-jib 22.

On the other hand, and as visible in FIG. 2, during the slinging manipulation operations of the strut structure 3, in particular on the ground when the strut structure 3 is lifted to straighten it or conversely when the strut structure 3 is lowered to lay it down, the at least one toggle leg 8 is in its toggled position, so that its lower end 80 forms a toggle footing for the strut structure 3 on the ground (see the zoom in FIG. 2) when the strut arm 4 passes from a horizontally lying position to a vertically raised position, or vice versa.

1. A strut structure for a crane, comprising:
a strut arm including a foot and a top;
at least one tie rod including an upper tie rod end fastened to the top of the strut arm;
at least one reinforcing bar including an upper bar end fastened to the strut arm, between the foot and the top;
said strut structure being characterized in that the strut arm is divided into an upper strut half-arm and a lower strut half-arm assembled end to end by a detachable intermediate mechanical connection, the foot forming part of the lower strut half-arm and the top forming part of the upper strut half-arm;
and in that the upper bar end of the at least one reinforcing bar is fastened to the lower strut half-arm; and
so that the strut structure is detachable into two sub-assemblies, after disassembly of the detachable intermediate mechanical connection, which are an upper sub-assembly comprising the upper strut half-arm and the at least one tie rod, and a lower sub-assembly comprising the lower strut half-arm and the at least one reinforcing bar.

2. The strut structure according to claim 1, comprising at least one connecting element for a mechanical connection between the at least one reinforcing bar and the at least one tie rod, wherein the at least one reinforcing bar includes a lower bar end fastened to the at least one connecting element, and the at least one tie rod includes a lower tie rod end which is assembled on the at least one connecting element by at least one detachable lower mechanical connection, so that the lower sub-assembly comprises the at least one connecting element, fastened to the at least one reinforcing bar, after disassembly of the at least one detachable lower mechanical connection.

3. The strut structure according to claim 2, wherein the at least one detachable lower mechanical connection is a pin connection which comprises at least one lower connecting pin providing a junction between the lower tie rod end of the at least one tie rod and the connecting element.

4. The strut structure according to claim 2, wherein the lower bar end of the at least one reinforcing bar is securely fastened to the at least one connecting element by welding.

5. The strut structure according to claim 3, wherein the at least one reinforcing bar includes a length adjustment arrangement for adjusting the length of the at least one reinforcing bar.

6. The strut structure according to claim 5, wherein the length adjustment arrangement comprises a screw tensioner equipped with a nut with reverse threads such as a lantern nut.

7. The strut structure according to claim 1, wherein the detachable intermediate mechanical connection is a pin connection which comprises at least one intermediate connecting pin providing a junction between the upper strut half-arm and the lower strut half-arm.

8. The strut structure according to claim 7, wherein the upper strut half-arm comprises a lower end on the opposite side of the top, the lower strut half-arm comprises an upper end on the opposite side of the foot and the at least one intermediate connecting pin provides a junction between this lower end and this upper end.

9. The strut structure according to claim 8, wherein the upper bar end of the at least one reinforcing bar is fastened to the upper end of the lower strut half-arm.

10. The strut structure according to claim 5, wherein the strut arm includes two sections of the strut arm, which are a right section of the strut arm and a left section of the strut arm, wherein:
the right section of the strut arm is divided into an upper right half-section of the strut arm and a lower right half-section of the strut arm assembled end to end by the detachable intermediate mechanical connection;
the left section of the strut arm is divided into an upper left half-section of the strut arm and a lower left half-section of the strut arm assembled end to end by the detachable intermediate mechanical connection;
the upper strut half-arm comprises the upper right half-section of the strut arm and the upper left half-section of the strut arm secured to each other; and
the lower strut half-arm comprises the lower right half-section of the strut arm and the lower left half-section of the strut arm secured to each other.

11. The strut structure according to claim 10, wherein the at least one tie rod comprises two tie rods which are a right tie rod and a left tie rod fastened respectively to the upper right half-section of the strut arm and the upper left half-section of the strut arm.

12. The strut structure according to claim 10, wherein the at least one reinforcing bar includes two reinforcing bars which are a right reinforcing bar and a left reinforcing bar fastened respectively to the lower right half-section of the strut arm and the lower left half-section of the strut arm.

13. The strut structure according to claim 12, wherein the right reinforcing bar and the left reinforcing bar each include the length adjustment arrangement.

14. The strut structure according to claim 2, wherein the at least one connecting element comprises two connecting elements which are a right connecting element and a left connecting element, where the right reinforcing bar is fastened to the right connecting element and the left reinforcing bar is fastened to the left connecting element.

15. The strut structure according to claim 11, wherein the at least one detachable lower mechanical connection comprises a right detachable lower mechanical connection and a left detachable lower mechanical connection which respectively connect the right tie rod to the right connecting element and the left tie rod to the left connecting element.

16. The strut structure according to claim 1, wherein the upper sub-assembly has a first mass which is less than 10 tons, the lower sub-assembly has a second mass which is less than 10 tons and the strut structure has a total mass which corresponds to the sum of the first mass and the second mass and which is greater than 10 tons.

17. A crane comprising a rotating part at the top of a mast, said rotating part comprising a jib holder, a jib hinged on the jib holder, a counter-jib mounted on the jib holder and a strut structure according to claim 1, wherein the foot of the strut arm is assembled on the counter-jib by a first detachable mechanical connection, the at least one tie rod and the at least one reinforcing bar are assembled on the counter-jib by a second detachable mechanical connection.

18. The crane according to claim 17, wherein the strut structure is according to claim 2 and the at least one connecting element is assembled on the counter-jib by the second detachable mechanical connection.
